(19) United States
(12) Patent Application Publication
(10) Pub. No.: US 2009/0103295 A1
(43) Pub. Date: Apr. 23, 2009

(54) LED unit and LED module

(75) Inventor: Tiger Wang, Taipei (TW)

Correspondence Address: CHARLES E. BAXLEY, ESQUIRE, 90 JOHN STREET, SUITE 309, NEW YORK, NY, 10038, US

(73) Assignee: Keeper Technology Co., Ltd.

(21) Appl. No.: 11/975,027

(22) Filed: Oct. 17, 2007

(51) Int. Cl. F21V 21/00; F21V 29/00

(52) U.S. Cl. 362/234; 362/373; 362/382; 362/253; 362/249.02

(57) ABSTRACT

A light emitting diode (LED) unit has a pair of substrates, an LED and a pair of brackets. The substrates are separated from and serve respectively as positive and negative electrodes. The LED is mounted on the substrates and has a pair of terminals mounted respectively on the substrates. The brackets serve respectively as positive and negative electrodes, are made of pliable and flexible metal and are mounted respectively on and electrically connected respectively to the substrates. At least one of the brackets serves as at least one three-dimensional (3D) bracket being non-flat. The 3D brackets are easily customized into various configurations by bending or stamping semi-finished 3D brackets to fit internal chambers or cavities of different lights such as vehicle lights. Accordingly, the cost of the LED modules is effectively lowered.

### BACKGROUND OF THE INVENTION

1. Field of the Invention

The present invention relates to a light emitting diode (LED) unit, and more particularly to LED units that are mounted on at least one pliable three-dimensional conductive bracket to form an LED module.

2. Description of Related Art

Light emitting diodes (LED) are light, compact, bright and have low temperature when active. Therefore, LEDs are applied to numerous kinds of lighting devices such as lamps, flashlights, emergency lights, searchlights and vehicle lights.

A conventional LED comprises a chip, a plastic casing and a pair of terminals. The plastic casing encapsulates the chip. The terminals extend in the plastic casing, are connected to the chip and may be soldered on a printed circuit board (PCB). One terminal is mounted on and directly contacts the chip. The other terminal is connected electrically to the chip by a wire-bonding means.

A conventional LED assembly for a vehicle light comprises multiple LEDs, multiple pairs of metal boards, multiple PCBs, a plastic bracket and multiple wires. The metal boards of each pair are mounted respectively to the terminals of a corresponding LED. Each PCB is mounted on a corresponding pair of the metal board. The plastic bracket is formed into a specific shape corresponding to a cavity of the vehicle light, is mounted into the cavity and holds the PCBs having the LEDs. The wires are connected to the metal boards so that the LEDs are connected electrically to one another in parallel or in series.

However, the plastic bracket is not pliable or flexible and may only fitted in a corresponding vehicle light cavity. Accordingly, a manufacturer of LED assemblies needs to forms various plastic brackets for different vehicle light designs. Furthermore, mounting the wires on the metal boards wastes material and time and lowers a production rate of the LED assembly. Therefore, the LED assembly has a high cost.

To overcome the shortcomings, the present invention provides an LED unit to mitigate or obviate the aforementioned problems.

### SUMMARY OF THE INVENTION

The main objective of the invention is to provide LED units that are mounted on at least one pliable three-dimensional conductive bracket to form an LED module.

A light emitting diode (LED) unit in accordance with the present invention comprises a pair of substrates, an LED and a pair of brackets. The substrates are separated from and serve respectively as positive and negative electrodes. The LED is mounted on the substrates and has a pair of terminals mounted respectively on the substrates. The brackets serve respectively as positive and negative electrodes, are made of pliable and flexible metal and are mounted respectively on and electrically connected respectively to the substrates. At least one of the brackets serves as at least one three-dimensional (3D) bracket being non-flat. Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a light emitting diode (LED) module in accordance with the present invention;

FIG. 2 is an exploded perspective view of the LED module in FIG. 1;

FIG. 3A is a front view in partial section of a first variant of an LED unit in accordance with the present in the LED module in FIG. 1;

FIG. 3B is a front view in partial section of a second variant of the LED unit in the LED module in FIG. 1;

FIG. 4 is a perspective view of a second embodiment of an LED module in accordance with the present invention; and

FIG. 5 is an enlarged perspective view of the LED module in FIG. 4.

### DETAILED DESCRIPTION OF THE PREFERRED EMBODIMENT

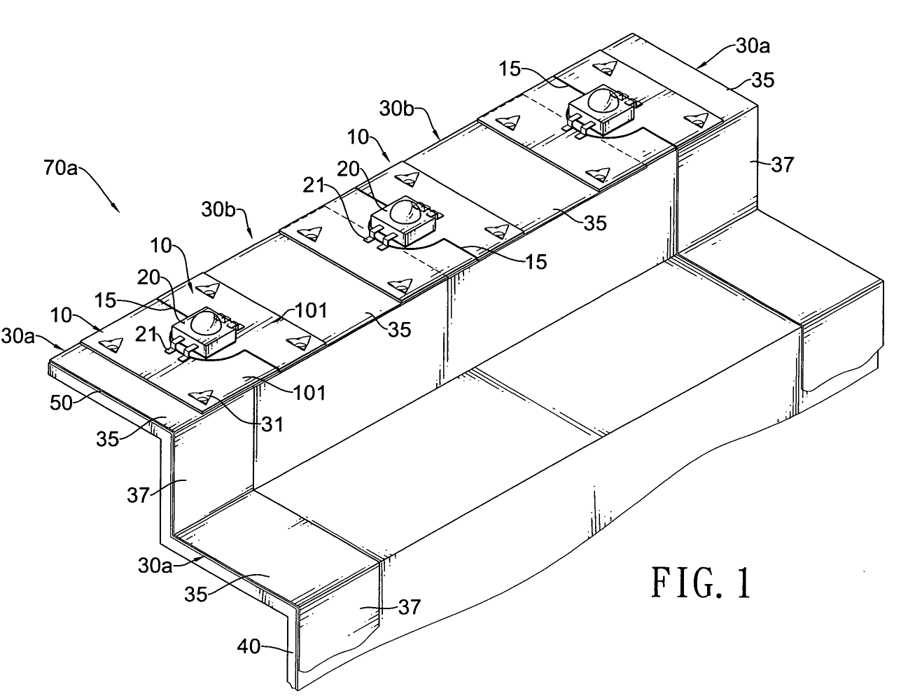

With reference to FIGS. 1, 3A and 4, multiple light emitting diode (LED) units (60) in accordance with the present invention are mounted in an LED module (70a, 70b) in accordance with the present invention.

With reference to FIGS. 1, 2 and 3A, a first embodiment of the LED module (70a) comprises multiple LED units (60). Each LED unit (60) comprises a pair of substrates, an LED (20), a pair of brackets (30a, 30b) and may further have a heat sink (40) and a heat-sink insulation layer (50).

The substrates (10, 10a), being electrically conductive, are separated from each other by a gap (15) and serves respectively as positive and negative electrodes. Each substrate (10, 10a) may further have a base and an insulation layer (101) and multiple mounting holes (102).

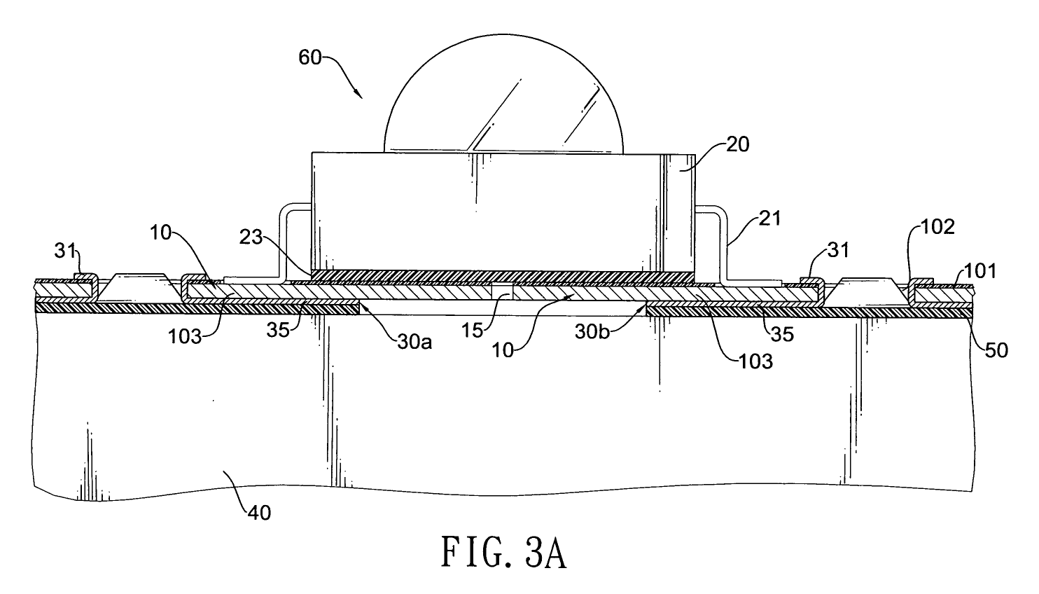

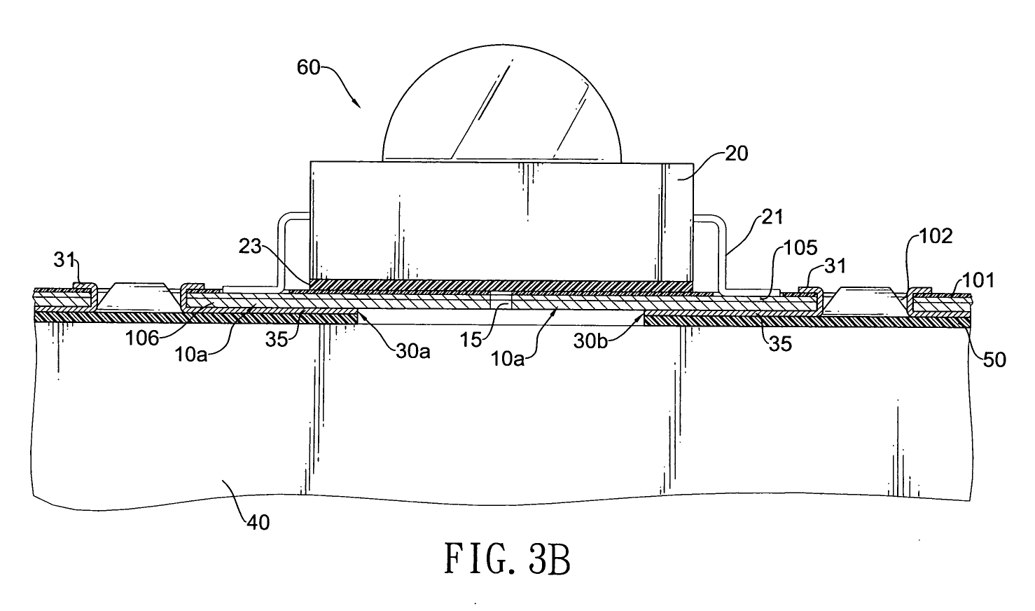

The base, being electrically conductive, has an outer surface and an inner surface. The inner surface is opposite to the outer surface. A first variant of the base is a copper base (103) formed into a single piece. With further reference to FIGS. 3B, a second variant of the base is laminated and has an aluminum board (106) and a copper board (105). The copper board (105) is attached to he aluminum board (106).

The insulation layer (101) being electrically insulating, is attached to the outer surface of the base and is attached to the copper board (105) of the second variant of the base to set the copper board (105) between the aluminum board (106) and the insulation board (101).

The mounting holes (102) are defined through the base and the insulation layer (101) of the substrate (10, 10a).

The LED (20) is mounted on the pair of the substrates (10, 10a), may be located on the insulation layer (101), has a bottom, a pair of terminals (21) and may further have a thermally conductive layer (23). The terminals (21) are mounted respectively on the bases of the substrates (10, 10a), may be through the insulation layers (101) and may be mounted on the cooper board (105) of the second variant of the base. The thermally conductive layer (23), being electrically insulating, is mounted on the bottom of the LED (20), contacts the substrates (10, 10a), may contact the insulation layers (101) and may be selected from a group consisting of heat conducting paste, a ceramic pad and a silicone rubber.

With reference to FIGS. 1, 2, 4 and 5, the brackets (30a, 30b), serving respectively positive and negative electrodes to be connected to a external power source through wires, are made of pliable and flexible metal such as copper or aluminum and are mounted respectively on and electrically connected respectively to the substrates (10, 10a). In each of some of the LED units (60), at least one of the brackets (30a) serves as at least one three-dimensional (3D) bracket. When one brackets (30a) is the 3D bracket, the other bracket (30b) serves as a separate connector. In each of remains of the LED units (60), both the brackets serve as separate connectors.

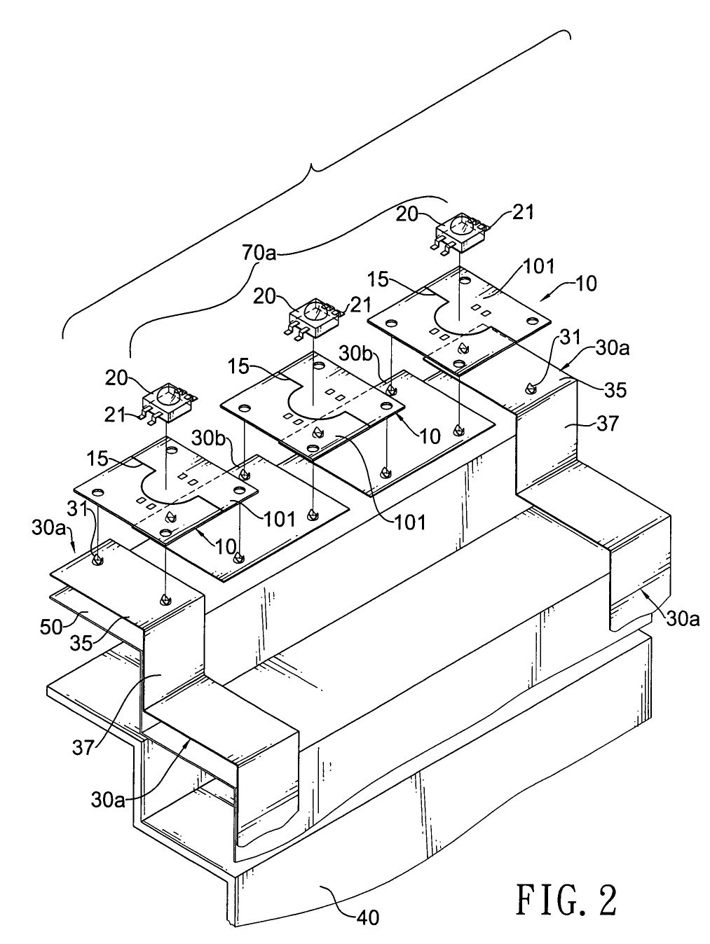

In a first embodiment of the LED module (70a), the LED units (60) are classified into first sets of the LED units (60) and second sets of the LED units (60). Each second sets is electrically connected between adjacent first sets. Each LED unit (60) of each first set has one bracket (30a) being a 3D bracket and the other bracket (30b) being a separate connector. Each LED unit (60) of each second set has both brackets (30b) being separate connectors, as shown in FIGS. 1 and 2.

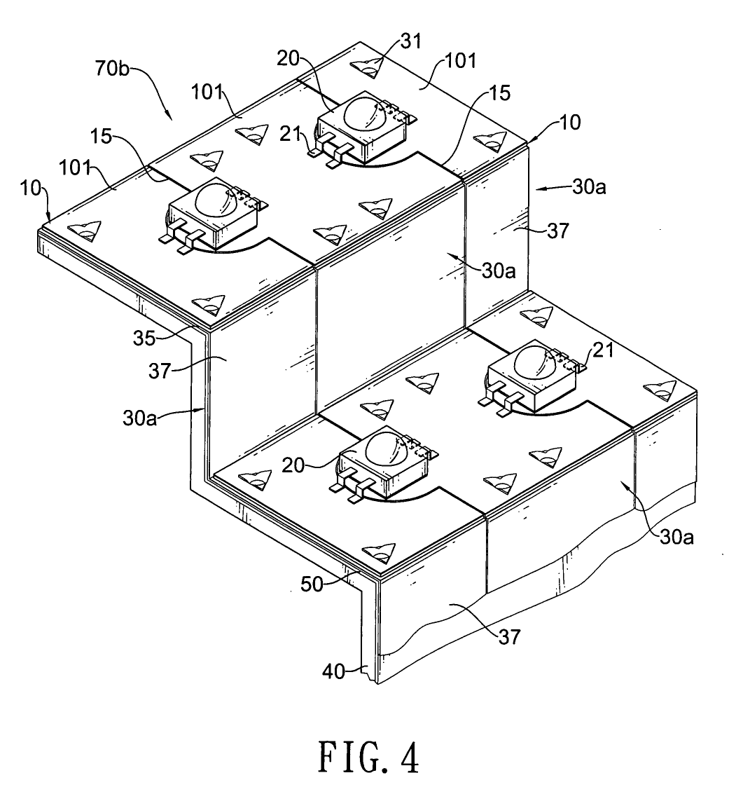

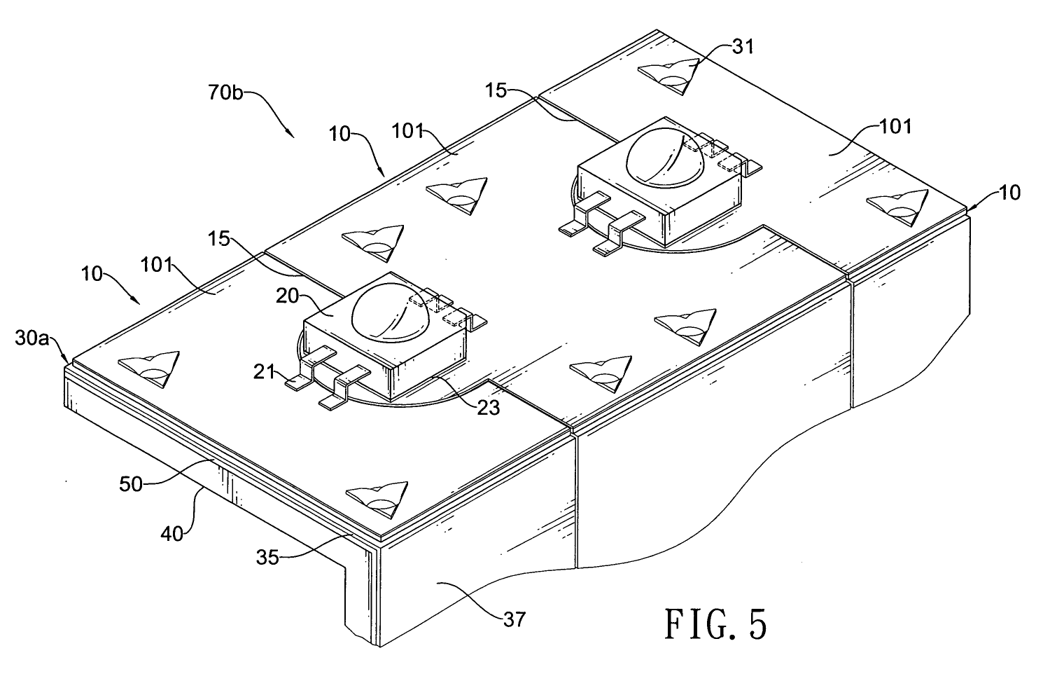

In a second embodiment, both the brackets (30a) of each LED units (60) are 3D brackets, as shown in FIGS. 4 and 5.

The 3D bracket of each LED unit (60), being non-flat, may be stepped, inclined or curved, is mounted one of the substrates (10, 10a), may be mounted on adjacent substrates (10, 10a). The 3D brackets of the LED units (60) are connected integrally to one another to form at least one 3D bracket module being non-flat, serving as at least one positive or negative electrode and holding a number of the LEDs (20). Each 3D bracket module is connected to some of the LEDs (20). In the first embodiment, two 3D brackets are arranged on opposite sides of the LED modules (70a). In the second embodiments, three 3D brackets are arranged in the LED modules (70b). Semi-finished 3D bracket modules may be a flat board manufactured by a single processing. Furthermore, the semi-finished 3D bracket modules are further formed into finished 3D bracket modules with different configurations for various lights such as vehicle lights including headlights and taillights. Each 3D bracket has an integrated connector (35) and a connection tab (37).

The integrated connector (35) is mounted on and connected electrically to the inner surface of the base of one of the pairs of the substrates (10, 10a) of the LED unit (60) and may be mounted on the inner surface of the base of one of the substrates (10, 10a) of an adjacent LED unit (60). The integrated connector (35) may have at least one set of multiple fasteners (31). The fasteners (31) of each set are formed on the integrated connector (35), may be rivets and are securely mounted respectively through the mounting holes of one substrate (10, 10a) so that the substrate (10, 10a) is mounted securely on the integrated connector (35).

The connection tab (37) is formed on and protrudes from the integrated connector (35) and is connected integrally to the integrated connector (35) of an adjacent LED unit (60). The connection tab (37) may be connected to the integrated connector (35) at an angle, may be connected smoothly to the integrated connector (35) in a curved configuration.

Each separate connector of each LED unit (60) in the first embodiment is flat, is mounted on and connected electrically to the inner surface of the base of one of the pairs of the substrates (10, 10a) of the LED unit (60) and may be mounted on the inner surface of the base of one of the substrates (10, 10a) of an adjacent LED unit (60). The separate connector may have two sets of the fasteners (31). The fasteners (31) of each set are formed on the separate connector (35), may be rivets and are securely mounted respectively through the mounting holes of one substrate (10, 10a) so that the substrate (10, 10a) is mounted respectively on the separate connector.

The heat sink (40) is mounted on all of the brackets (30a, 30b) and is selected from a group consisting of copper and aluminum.

The heat-sink insulation layer (50) is electrically insulating and is mounted between the heat sink (40) and all of the brackets (30a, 30b).

Each 3D bracket is connected to multiple LEDs (20) so that wires to connect adjacent LEDs (20) may be economically saved and time of assembling the wires to the LEDs (20) are avoided. Furthermore, the 3D brackets may be easily customized into various configurations by bending or stamping the semi-finished 3D brackets to fit internal chambers or cavities of different lights such as vehicle lights including headlights or taillights. Therefore, an LED module manufacturer only requires a single manufacturing system to produce the same semi-finished 3D brackets or semi-finished LED modules (70a, 70b) for every different light. Accordingly, economies of scale reduce costs of the LED modules (70a, 70b) and vehicle lights.

Even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A light emitting diode (LED) unit comprising:
a pair of substrates being electrically conductive, separated from each other by a gap and serving respectively as positive and negative electrodes;
an LED mounted on the substrates and having a bottom and a pair of terminals mounted respectively on the substrates; and
a pair of brackets serving respectively as positive and negative electrodes, made of pliable and flexible metal and mounted respectively on and electrically connected respectively to the substrates, and at least one of the brackets serving as at least one three-dimensional (3D) bracket being non-flat.

2. The LED unit as claimed in claim 1, wherein each substrate has
a base being electrically conductive, having an outer surface and an inner surface being opposite to the outer surface; and
an insulation layer being electrically insulating, attached to the outer surface of the base.

3. The LED unit as claimed in claim 2, wherein the LED further has a thermally conductive layer being electrically insulating, mounted on the bottom of the LED and contacting the insulation layers of the substrates.

4. The LED unit as claimed in claim 3, wherein
each substrate further has multiple mounting holes defined through the insulation layer and the base of the substrate; and
each of the brackets further has at least one set of multiple fasteners formed on the bracket, and the fasteners of each set are securely mounted respectively through the mounting holes of one substrate.

5. The LED unit as claimed in claim 4, wherein each fastener is a rivet.

6. The LED unit as claimed in claim 5, wherein the base of each substrate is a copper base.

7. The LED unit as claimed in claim 6, wherein:
the base of each substrate is laminated and has an aluminum board and a copper board attached to the aluminum board; and
the insulation layer of each substrate is attached to the copper board of the base to set the copper board between the aluminum board of the insulation board.

8. The LED unit as claimed in claim 7, wherein a heat sink is mounted on the brackets and is selected from a group consisting of copper and aluminum.

9. The LED unit as claimed in claim 8, wherein a heat-sink insulation is electrically insulating and is mounted between the heat sink and the brackets.

10. An LED module comprising multiple LED units and each LED unit having
a pair of substrates being electrically conductive, separated from each other by a gap and serving respectively as positive and negative electrodes;
an LED mounted on the pair of the substrates and having a bottom and a pair of terminals mounted respectively on the substrates; and
a pair of brackets made of pliable and flexible metal and mounted respectively on and electrically connected respectively to the substrates, wherein
in each of some of the LED units, at least one of the bracket serves as at least one 3D bracket being non-flat; and
the 3D brackets of the LED units are connected integrally to one another to form at least one 3D bracket module being non-flat, serving as at least one electrode and holding a number of the LEDs.

11. The LED module as claimed in claim 10, wherein the brackets are made of copper.

12. The LED module as claimed in claim 11, wherein each substrate has
a base being electrically conductive, having an outer surface and an inner surface being opposite to the outer surface; and
an insulation layer being electrically insulating, attached to the outer surface of the base.

13. The LED module as claimed in claim 12, wherein each LED further has a thermally conductive layer being electrically insulating, mounted on the bottom of the LED and contacting the insulation layers of the substrates.

14. The LED module as claimed in claim 13, wherein
each substrate of each LED unit further has multiple mounting holes defined through the insulation layer and the base of the substrate; and
each of the brackets of each LED unit further has at least one set of multiple fasteners formed on the bracket, and the fasteners of each set are securely mounted respectively through the mounting holes of one substrate.

15. The LED module as claimed in claim 14, wherein each fastener is a rivet.

16. The LED module as claimed in claim 15, wherein the base of each substrate is a copper base.

17. The LED module as claimed in claim 16, wherein:
the base of each substrate is laminated and has an aluminum board and a copper board attached to the aluminum board; and
the insulation layer of each substrate is attached to the copper board of the base to set the copper board between the aluminum board of the insulation board.

18. The LED module as claimed in claim 17, wherein a heat sink is mounted on the brackets and is selected from a group consisting of copper and aluminum.

19. The LED module as claimed in claim 18, wherein a heat-sink insulation is electrically insulating and is mounted between the heat sink and the brackets.

20. The LED module as claimed in claim 13, wherein the thermally conductive layer is selected from a group consisting of heat conducting paste, a ceramic pad and a silicone rubber.
